(19) United States
(12) Patent Application Publication
(10) Pub. No.: US 2003/0156855 A1
(43) Pub. Date: Aug. 21, 2003

(54) Developer container, developing container, developing device, process cartridge, side cover, bearing structrue, and image forming apparatus

(75) Inventors: Susumu Nittani, Shizuoka (JP); Kanji Yokomori, Kanagawa (JP); Koji Hashimoto, Shizuoka (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 10/367,870

(22) Filed: Feb. 19, 2003

(30) Foreign Application Priority Data
Feb. 20, 2002 (JP) 2002-042533

(51) Int. Cl. G03G 15/08

(52) U.S. Cl. 399/106

(57) ABSTRACT

A developer container of a developing device that is provided in an image forming apparatus, including: a developer container main body provided with a developer containing portion that contains a developer and a developer supply opening; a sealing member that seals the developer supply opening of the developer container main body; and a grip member for pulling out the sealing member in a longitudinal direction of the developer container main body, in which the developer container main body and the grip member are integrally molded from resin materials having low compatibility to be separable from each other, and the grip member has a longitudinal dimension extending to an outside of a developer container mounting region of the image forming apparatus.

### BACKGROUND OF THE INVENTION

1. Field of the Invention

The present invention relates to a developer container, a developing container, a developing device, a process cartridge, a side cover, and a bearing structure mounted on an image forming apparatus such as a copier or a printer adopting an electrophotographic process, and an image forming apparatus.

2. Related Background Art

Conventionally, image forming apparatuses using an electrophotographic image forming process adopt a process cartridge system in which an electrophotographic photosensitive member, process means for acting on the electrophotographic photosensitive member, a developing device and the like are integrated in a cartridge, and the cartridge is detachably mountable to the image forming apparatus. According to the process cartridge system, a user can perform operational maintenance of the apparatus without relying on a serviceman, so that the operability can be remarkably enhanced. Thus, the process cartridge system is widely used in image forming apparatuses.

In the above-mentioned developing device and process cartridge, the following is proposed: a developer container (toner container) containing a developer (toner) is connected to a developing container holding a developer bearing member (developing roller), a developer regulating member (developing blade) and the like, and an opening of the toner container for supplying toner to the developing container is sealed with a sealing member (toner seal) for sealing a developer, whereby toner is prevented from flowing to the developing container before the commencement of use. A user pulls a seal grip (pull-tab) provided to the process cartridge at the commencement of use, removes the toner seal fixed to the seal grip, and thereafter, mounts a process cartridge to the image forming apparatus.

In order to make use of the above-mentioned cartridge type image forming apparatus further widespread, higher efficiency of mounting/detaching operation of a process cartridge, enhancement of reliability and safety of an operation, a decrease in cost by reduction of the number of components and the number of processes, and the like are desired.

### SUMMARY OF THE INVENTION

The present invention has been made in view of the above-mentioned unsolved problem of the conventional art. An object of the present invention is as follows: a grip (seal grip) of a toner seal is designed so as to be pulled out in a longitudinal direction of a process cartridge; the seal grip is placed on an outer side in a longitudinal direction from a guide width set for mounting/detaching a process cartridge of an image forming apparatus; and the process cartridge is adapted such that it cannot be mounted to the image forming apparatus unless the seal grip is removed. Therefore, an image forming operation is prevented from being started under the condition that toner is not supplied to the developing container to damage the process cartridge. Furthermore, the invention provides a developer container, a developing container, a developing device, a process cartridge, a side cover, a bearing structure, and an image forming apparatus, which can contribute to the enhancement of efficiency and reliability of a mounting/detaching operation of a process cartridge.

Another object of the present invention is as follows: a toner container, a developing container, a bearing member or a side cover, and a seal grip are integrally molded by two-color molding from materials having low mutual compatibility, such that they are separable from each other. Because of this, the number of components, the number of assembly processes, and the like can be reduced. Furthermore, the dimension stability of the toner container, the developing container, the bearing member, or a fitting portion between the side cover and the seal grip is ensured, thereby reducing a force required for separating the seal grip. Furthermore, an inexpensive construction is realized which is capable of preventing the seal grip from coming off due to vibration or the like during transportation.

Another object of the present invention is as follows: the seal grip is molded by two-color molding as described above so that the color of the seal grip can be set arbitrarily without increasing the number of components, whereby a user can easily discriminate the seal grip when removing a toner seal in an operation of mounting a process cartridge.

Another object of the present invention is to provide a developer container of a developing device provided in an image forming apparatus, including: a developer container main body provided with a developer containing portion that contains a developer and a developer supply opening; a sealing member that seals the developer supply opening of the developer container main body; and a grip member for pulling out the sealing member in a longitudinal direction of the developer container main body, in which the developer container main body and the grip member are integrally molded from using resin materials having low mutual compatibility so as to be separable from each other, and the grip member has a longitudinal dimension extending to an outside of a developer container mounting region of the image forming apparatus.

Another object of the present invention is to provide a developer container, which cannot be mounted to an image forming apparatus main body unless a seal grip is removed, a developing container, a developing device, a process cartridge, a side cover, a bearing structure and an image forming apparatus.

Another object of the present invention is to provide a developer container, a developing container, a developing device, a process cartridge, a side cover, and a bearing structure in which mounting operability is enhanced, and an image forming apparatus.

Another object of the present invention is to provide a developer container, a developing container, a developing device, a process cartridge, a side cover, and a bearing structure in which reduction in the number of components and reduction in the number of assembling processes are realized, and an image forming apparatus.

These and other objects, features and advantages of the present invention will become more apparent upon consideration of the following description of the preferred embodiments of the present invention taken in conjunction with the accompanying drawings.

### BRIEF DESCRIPTION OF THE DRAWINGS

FIG. 1 is a schematic cross-sectional view showing a multicolor image forming apparatus according to a first embodiment of the invention.

FIG. 2 is an exploded perspective view showing a process cartridge of FIG. 1 in a disassemble state.

FIG. 3 is a schematic cross-sectional view showing a process cartridge.

FIG. 4 is a perspective view showing a toner container.

FIG. 5 is a perspective view showing a toner container with a toner seal attached thereto.

FIGS. 6A, 6B, and 6C illustrate a seal grip and an end portion of a toner seal.

FIG. 7 illustrates an elastic sealing member of a developing container.

FIG. 8 shows a state where a developing container and a toner container are integrated as a unit.

FIGS. 9A and 9B are plan views showing a seal grip, in which FIG. 9A shows a state before a toner seal is pulled out, and FIG. 9B shows a state after the toner seal is pulled out.

FIG. 10 is a cross-sectional view showing a connection portion between a toner container and a seal grip.

FIGS. 11A and 11B illustrate another embodiment of a structure for connecting a toner seal to a toner container.

FIG. 12 is an elevation showing a toner container according to a second embodiment.

FIG. 13 is an elevation showing a developing container according to the second embodiment of the invention.

FIG. 14 is a cross-sectional view showing a connection portion between a developing container and a seal grip according to the second embodiment of the invention.

FIG. 15 is a perspective view showing a developing apparatus according to a third embodiment of the invention.

FIGS. 16A and 16B illustrate a bearing member and a seal grip according to the third embodiment of the invention.

FIG. 17 is a cross-sectional view showing a connection portion between the bearing member and the seal grip according to the third embodiment of the invention.

FIG. 18 is a perspective view showing a developing device according to a fourth embodiment of the invention.

FIG. 19 is an elevation showing a side cover and a seal grip according to the fourth embodiment of the invention.

FIGS. 20A and 20B illustrate a bearing member according to a fourth embodiment of the invention.

FIG. 21 is a cross-sectional view showing a connection portion between a side cover and a seal grip according to the fourth embodiment of the invention.

FIGS. 22A and 22B illustrate a connection portion between a toner container and a seal grip according to a fifth embodiment of the invention.

FIG. 23 is a perspective view showing an image forming apparatus main body shown in FIG. 1.

FIG. 24 illustrates an attachment portion of a scanner unit for mounting it to the image forming apparatus.

FIG. 25 illustrates a method for mounting a process cartridge to the image forming apparatus.

### DESCRIPTION OF THE PREFERRED EMBODIMENTS

Hereinafter, the present invention will be described by way of illustrative embodiments with reference to the drawings.

(Entire Configuration of a Multicolor Image Forming Apparatus)

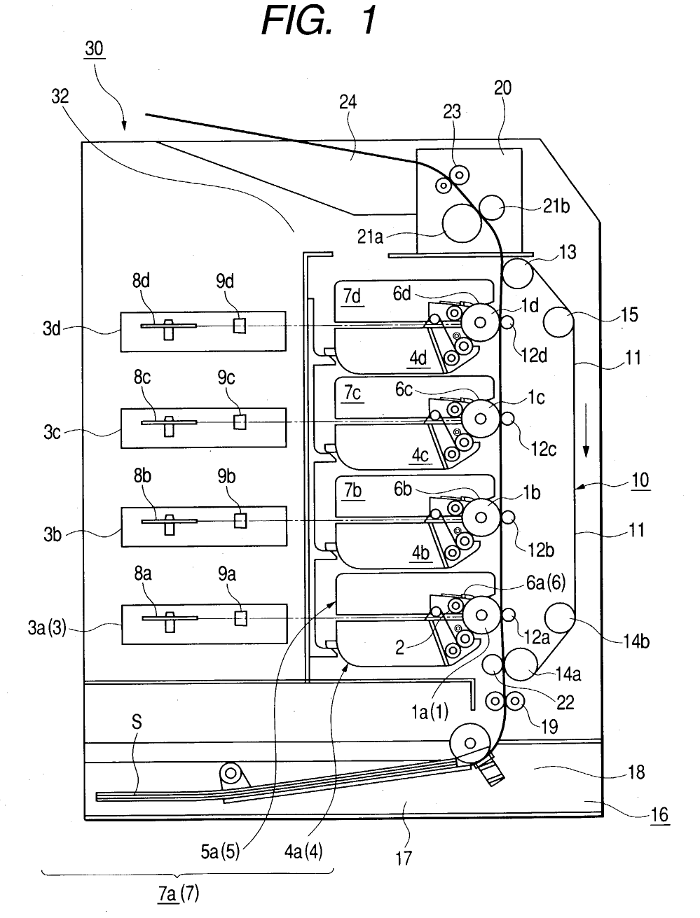

FIG. 1 is a vertical cross-sectional view showing an entire configuration of a full-color laser beam printer that is one embodiment of a multicolor image forming apparatus.

The multicolor image forming apparatus shown in FIG. 1 includes four photosensitive drums 1 (1a, 1b, 1c, 1d) arranged in parallel in a vertical direction. The photosensitive drums 1 are driven to rotate in a counterclockwise direction in FIG. 1 by a driving means (not shown). On the periphery of each photosensitive drum 1, there are provided, in the rotation direction of the photosensitive drum 1 in the following order, a charging device 2 for uniformly charging the surface of the photosensitive drum 1, a scanner unit 3 (3a, 3b, 3c, and 3d) for irradiating the photosensitive drum 1 with a laser beam based on image information to form an electrostatic latent image on the photosensitive drum 1, a developing device 4 (4a, 4b, 4c, and 4d) for allowing toner to adhere to the electrostatic latent image to develop it as a toner image, an electrostatic transfer device 10 for transferring the toner image on the photosensitive drum 1 to a transfer material S, a cleaning device 6 (6a, 6b, 6c, and 6d) for removing transfer residual toner remaining on the surface of the photosensitive drum 1 after transfer, a photosensitive drum unit 5 (5a, 5b, 5c, and 5d) including the photosensitive drum 1, and the like.

Herein, the drum unit 5 including the photosensitive drum 1, the charging device 2, the cleaning device 6, and the like is integrated with the developing device 4 in a cartridge to form a process cartridge 7 (7a, 7b, 7c, and 7d).

Hereinafter, the above-mentioned components will be described in detail. First, the photosensitive drum 1 will be described.

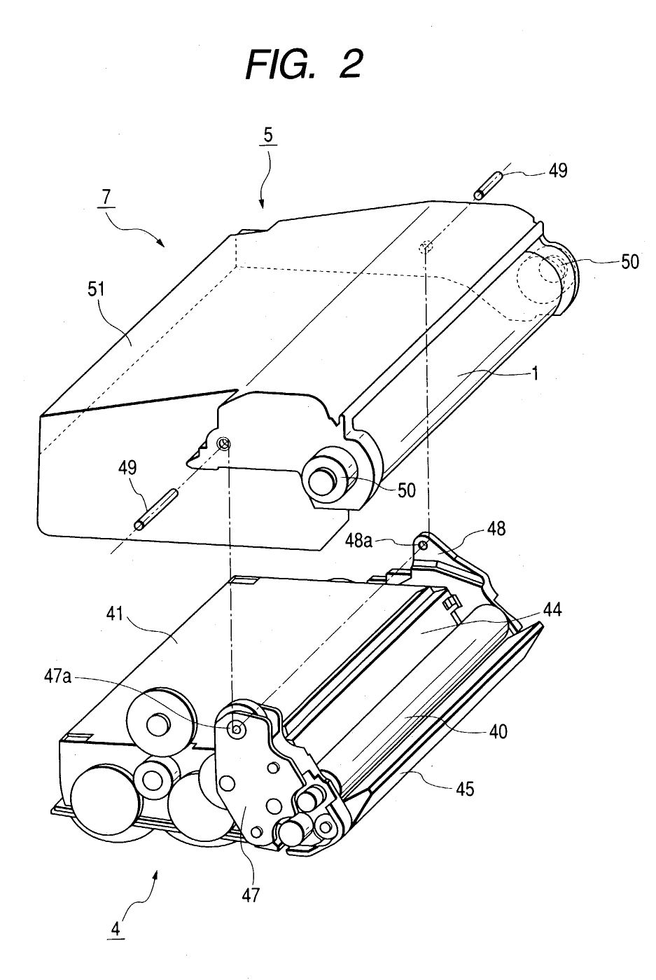

The photosensitive drum 1 is configured, for example, by coating an outer peripheral surface of an aluminum cylinder having a diameter of 30 mm with an organic photoconductive layer (OPC photosensitive member). The photosensitive drum 1 is rotatably supported by a drum bearing 50 (see FIG. 2) at both ends. A driving force is transmitted from a driving motor (not shown) to one end of the photosensitive drum 1, whereby the photosensitive drum 1 is rotated to be driven in a counterclockwise direction.

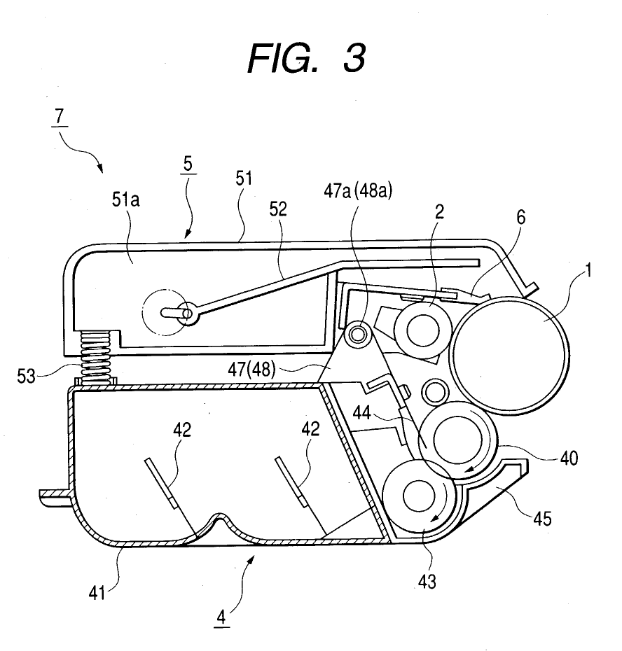

As the charging device 2, a contact charge type as shown in FIG. 3 can be used. The charging device 2 is a conductive roller formed in a roller shape. The roller is brought into contact with the surface of the photosensitive drum 1 and a charge bias voltage is applied to the roller, whereby the surface of the photosensitive drum 1 is uniformly charged.

The scanner units 3 (3a, 3b, 3c, and 3d) are arranged substantially in horizontal directions from the respective photosensitive drums 1. A laser diode (not shown) irradiates polygon mirrors 8 (8a, 8b, 8c, and 8d) to be rotated at a high speed by a scanner motor (not shown) with image light corresponding to an image signal. The surfaces of the charged photosensitive drums 1 are selectively exposed to the image light reflected from the polygon mirrors 8 via imaging lenses 9 (9a, 9b, 9c, and 9d), whereby electrostatic latent images are formed on the photosensitive drums 1.

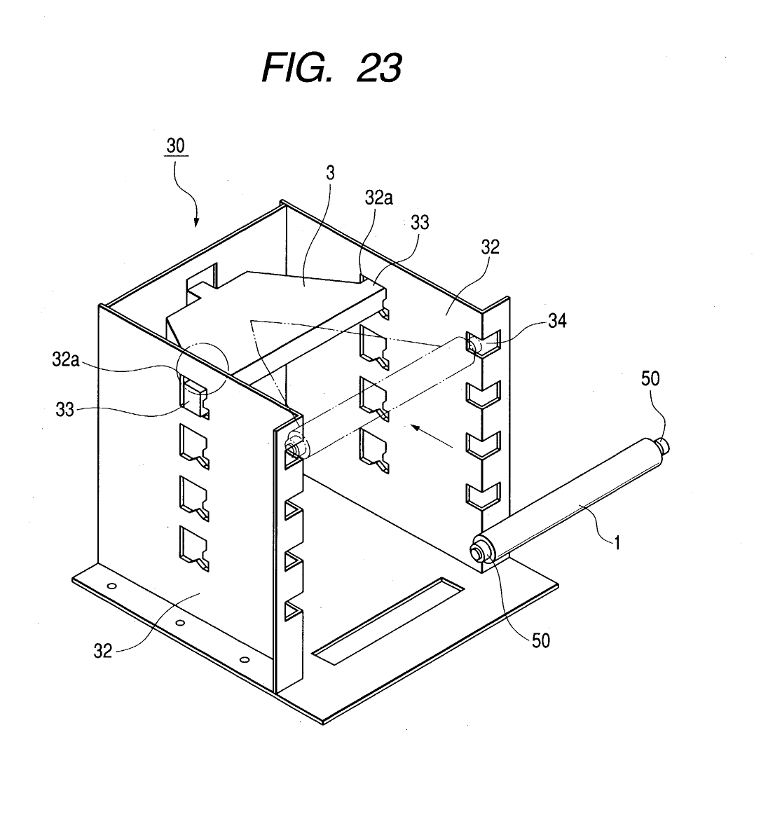

The scanner unit 3 is formed so as to have a length larger than a pitch between right and left side plates in the longitudinal direction as shown in FIG. 23, whereby projecting portions 33 of the scanner unit 3 project outside through opening holes 32a on the side plates 32 constituting an image forming apparatus main body 30. The scanner unit 3 is pressed by a compression spring 32b at its force of about 10 N in a downward direction indicated by the arrow at an angle of about 45° to the horizontal direction as shown in FIG. 24. Because of this, the scanner unit 3 can be reliably contacted and pressed against the side plates, whereby the scanner unit 3 is positioned.

The electrostatic transfer device 10 shown in FIG. 1 is provided with an electrostatic transfer belt 11 that is circled so as to be opposed to and come into contact with all the photosensitive drums 1a, 1b, 1c, and id. The electrostatic transfer belt 11 has a volume resistivity of 10¹¹ to 10¹⁴ (Ω·cm, for example, and is composed of a film-shaped member with a thickness of about 150 (μm. The electrostatic transfer belt 11 is supported by rollers with four axes in a vertical direction, and is circled so as to electrostatically attract a transfer material S to an outer peripheral surface thereof on the left side in FIG. 1 to bring the transfer material S into contact with the photosensitive drums 1. Because of this, the transfer material S is transported to a transfer position by the electrostatic transfer belt 11, and the toner images on the photosensitive drums 1 are transferred to the transfer material S.

Transfer rollers 12a, 12b, 12c, and 12d are arranged in parallel so as to be in contact with the inside of the electrostatic transfer belt 11 and opposed to four photosensitive drums 1a, 1b, 1c, and 1d. A positive charge is applied from these transfer rollers to the transfer material S via the electrostatic transfer belt 11, whereby negative polarity toner images on the photosensitive drums 1 are transferred to a sheet that is in contact with the photosensitive drums 1 by an electric field generated by the charge.

The electrostatic transfer belt 11 has a perimeter of about 700 mm, and is stretched around four rollers: a driving roller 13, driven rollers 14a, 14b, and a tension roller 15 to be rotated in a direction indicated by the arrow in FIG. 1. Because of this, a toner image is transferred while the above-mentioned electrostatic transfer belt 11 is circled, and the transfer material S is transported from the driven roller 14a side to the driving roller 13 side.

A feed portion 16 feeds the transfer material S to an image forming portion, and receives plural transfer materials S in a feed cassette 17. During image formation, a feed roller 18 (semicircular roller) and a registration roller pair 19 is rotated to be driven in accordance with an image forming operation, whereby the transfer materials S in the feed cassette 17 are separated and fed one by one. The leading edge of the transfer material S hits against the registration roller pair 19 to stop and form a loop. Thereafter, the rotation of the electrostatic transfer belt 11 and an image writing position are synchronized, and the transfer material S is fed to the electrostatic transfer belt 11 by the registration roller pair 19.

A fixing portion 20 fixes toner images of plural colors transferred to the transfer material S. The fixing portion 20 is composed of a heating roller 21a that is rotated, and a pressure roller 21b that is pressed against the heating roller 21a to give heat and a pressure to the transfer material S.

More specifically, the transfer material S with the toner images transferred from the photosensitive drums 1 thereto is transported by a pair of fixing rollers 21a, 21b and is given heat and a pressure by the pair of fixing rollers 21a, 21b while passing through the fixing portion 20. As a result, the toner images of plural colors are fixed on the surface of the transfer material S.

The operation of image formation is performed as follows. The process cartridges 7a, 7b, 7c, and 7d are driven successively in accordance with a printing timing, and the photosensitive drums 1a, 1b, 1c, and 1d are rotated to be driven in a counterclockwise direction in accordance with the driving. Then, the scanner units 3a, 3b, 3c, and 3d corresponding the respective process cartridges 7 are driven successively. Because of this driving, the charging rollers 2 uniformly charge the peripheral surfaces of the photosensitive drums 1. The scanner units 3 expose the peripheral surfaces of the photosensitive drums 1 to light in accordance with an image signal, thereby forming electrostatic latent images on the peripheral surfaces of the photosensitive drums 1. Developing rollers 40 of the developing devices 4 transfer toner to low potential portions of the electrostatic latent images to form (develop) toner images on the peripheral surfaces of the photosensitive drums 1.

The rotation of the registration roller pair 19 is started to feed the transfer material S to the electrostatic transfer belt 11 in such a manner as follows: the printing start position of the transfer material S is matched with an opposed point with respect to the electrostatic transfer belt 11 at a timing when the leading edge of the toner image on the peripheral surface of the most upstream photosensitive drum 1 is rotated to be transferred to the opposed point.

The transfer material S is pressed against the outer periphery of the electrostatic transfer belt 11 so as to be sandwiched between an electrostatic attracting roller 22 and the electrostatic transfer belt 11. Furthermore, a voltage is applied between the electrostatic transfer belt 11 and the electrostatic attracting roller 22, whereby a charge is generated in the transfer material S that is a dielectric and a dielectric layer of the electrostatic transfer belt 11 so as to electrostatically attract the transfer material S to the outer periphery of the electrostatic transfer belt 11. Because of this, the transfer material S is stably attracted to the electrostatic transfer belt 11 to be transferred to the most downstream transfer portion.

The toner images on the photosensitive drums 1a, 1b, 1c, and 1d are successively transferred to the transfer material S being transported due to the electric field formed between the photosensitive drums 1a, 1b, 1c, and 1d and the transfer rollers 12a, 12b, 12c, and 12d.

The transfer material S with the toner images of four colors transferred thereto is subjected to self stripping from the electrostatic transfer belt 11 by the curvature of a belt drive roller 13 and is placed in the fixing portion 20. The above-mentioned toner images are thermally fixed on the transfer material S in the fixing portion 20. Thereafter, the transfer material S is discharged outside from a discharge portion 24 by a discharge roller pair 23 under the condition that an image surface faces downward.

FIG. 2 shows the photosensitive drum unit 5 and the developing device 4 of the process cartridge 7 in an exploded state. The respective process cartridges 7a, 7b, 7c, and 7d of yellow, magenta, cyan, and black have the same configuration.

As shown in FIGS. 2 and 3, the process cartridge 7 is separated into the photosensitive drum unit 5 including the photosensitive drum 1, the charging device 2 and the cleaning device 6, and the developing device 4 including the developing roller 40 for developing an electrostatic latent image on the photosensitive drum 1.

In the photosensitive drum unit 5, the photosensitive drum 1 is rotatably attached to a cleaning frame 51 via the drum bearing 50. On the periphery of the photosensitive drum 1, the charging device (primary charging means) 2 for uniformly charging the surface of the photosensitive drum 1 and the cleaning device (cleaning blade) 6 for removing a developer (toner) remaining on the photosensitive drum 1 are placed. Furthermore, the residual toner removed from the surface of the photosensitive drum 1 by the cleaning device 6 is successively transported to a waste toner chamber 51a provided at the back of the cleaning frame 51 by a toner transportation mechanism 52. Then, by transmitting a driving force of a driving motor (not shown) to one end at the back in FIG. 3, the photosensitive drum 1 is rotated to be driven in a counterclockwise direction in FIG. 3 in accordance with an image forming operation.

The developing device 4 is composed of the developing roller 40 as a developer bearing member that is in contact with the photosensitive drum 1 while rotating in a direction indicated by the arrow, a toner container 41 that is a developer container main body for forming a developer containing portion containing toner (developer), and a developing container 45. The developing roller 40 is rotatably supported by the developing container 45 via bearing members 47 and 48. On the periphery of the developing roller 40, there are arranged a toner supply roller 43 that is in contact with the developing roller 40 while rotating in a direction indicated by the arrow and a developing blade 44 as a developer regulating member. Furthermore, a toner feeding mechanism 42 for feeding toner contained in the toner container 41 and transporting it to the toner supply roller 43 is provided in the toner container 41.

The developing device 4 has a suspension structure in which the entire developing device 4 is supported swingably with respect to the photosensitive drum unit 5 by a pin 49 around connection portions 47a and 48a provided respectively at the bearing members 47 and 48 attached to both ends of the developing device 4. In the state of a single body of the process cartridge (which is not attached to a printer main body), the developing device 4 is always biased by a compression spring 53 so that the developing roller 40 comes into contact with the photosensitive drum 1 by a rotation moment with respect to the pin 49.

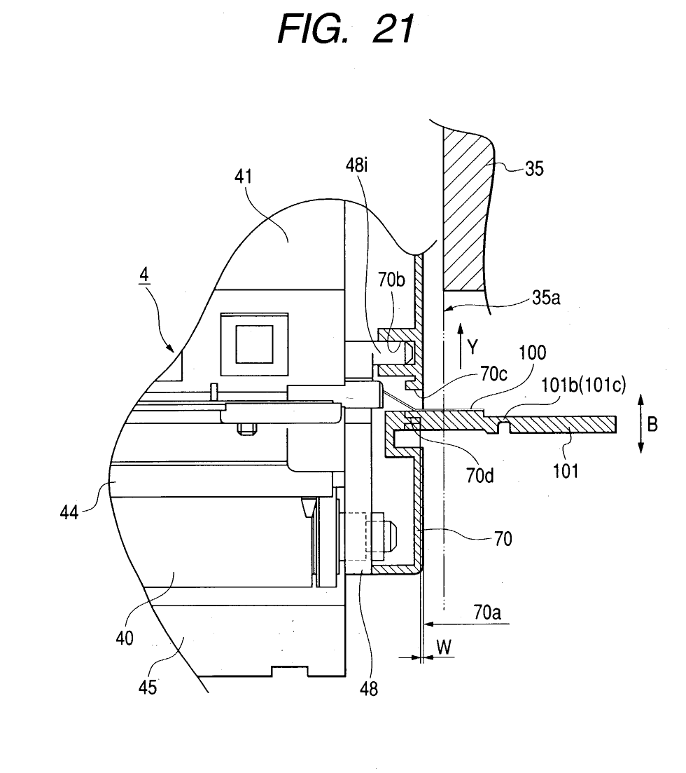

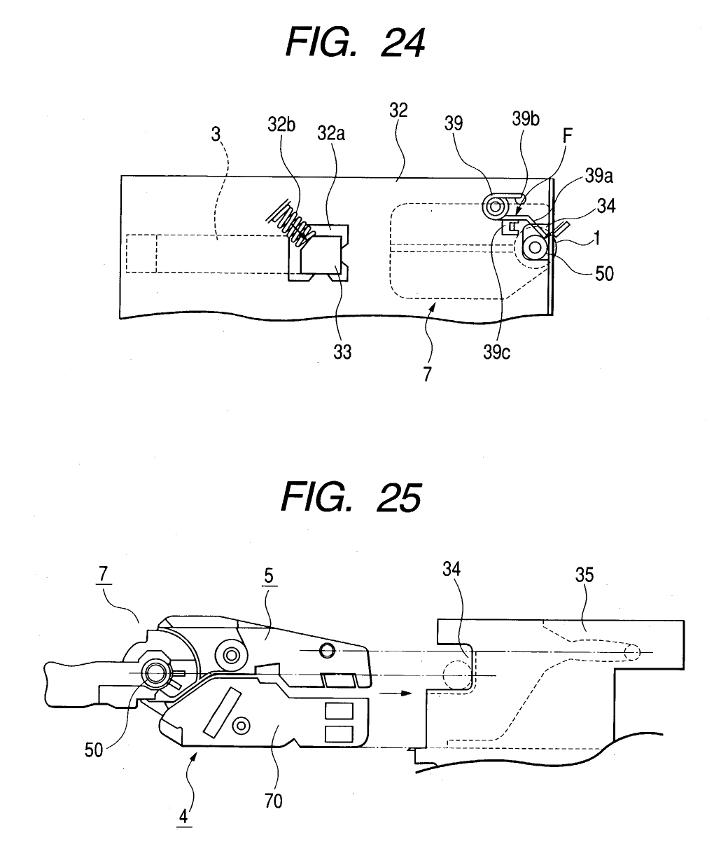

Furthermore, as shown in FIGS. 21 and 25, side covers 70 are provided outside of the bearing members 47 and 48 of the developing device 4. The side face of the photosensitive drum unit 5 and the side cover 70 of the developing device 4 form the side face of the process cartridge 7.

During development, when the contained toner is transported to the toner supply roller 43 by the toner transporting mechanism 42, the toner supply roller 43 that is rotated in the direction indicated by the arrow supplies the toner to the developing roller 40 by rubbing with respect to the developing roller 40 that is rotated in the same direction, thereby allowing the developing roller 40 to bear the toner. The toner borne on the developing roller 40 reaches the developing blade 44 along with the rotation of the developing roller 40. The developing blade 44 regulates the toner to form a predetermined toner thin layer. The regulated toner reaches a charging roller as a developer charging means along with the rotation of the developing roller 40, whereby a desired charge amount is given to the toner. Furthermore, the toner thin layer on the developing roller 40 is transported to a developing portion in which the photosensitive drum 1 is in contact with the developing roller 40. In the developing portion, the toner adheres to an electrostatic latent image formed on the surface of the photosensitive drum 1 due to a D.C. developing bias applied to the developing roller 40 from a power source (not shown), thereby developing a latent image. The toner remaining on the surface of the developing roller 40, which does not contribute to the development, is returned to the developing container 45 along with the rotation of the developing roller 40, and peeled to be collected from the developing roller 40 in the rubbing portion in which he toner supply roller 43 rubs against the developing roller 40. The collected toner is mixed and agitated with the remaining toner by the toner transporting mechanism 42, which also serves as a toner agitating mechanism for agitating the toner.

According to the contact development system for performing development under the condition that the photosensitive drum 1 is in contact with the developing roller 40 as in the present invention, it is preferable that the photosensitive drum 1 is made of a rigid main body, and the developing roller 40 has an elastic material. As the elastic material, a solid rubber single layer, a solid rubber layer coated with a resin considering the electrostatic charging property of the toner, or the like is used.

The process cartridge 7 is mounted to the image forming apparatus main body 30 as follows. Herein, the longitudinal direction refers to an axis direction of the photosensitive drum 1, and a cross-sectional direction refers to a direction orthogonal to the axis of the photosensitive drum 1.

As shown in FIGS. 23 to 25, the process cartridge 7 is mounted to the image forming apparatus main body 30 by guiding the process cartridge 7 to the inside of the apparatus main body along a process cartridge guide 35 in a direction indicated by the arrow shown in FIGS. 23 and 25, and inserting the drum bearing 50 supporting the photosensitive drum 1 into a guide groove 34. Then, the drum bearing 50 is pressed against a hitting surface of the guide groove 34 as represented by a broken line in FIG. 25, whereby the position of the process cartridge 7 is determined. On the other hand, in the longitudinal direction, rough guiding is performed with the process cartridge guide 35 and the side face of the process cartridge 7, and thereafter, the positioning portion on the side face of the photosensitive drum unit is pressed against a predetermined position of the image forming apparatus main body 30 by a pressurizing unit (not shown) from the side face of the image forming apparatus main body 30, whereby positioning in the longitudinal direction is completed.

The process cartridge 7 is held in the image forming apparatus main body 30 in a cross-sectional direction by a method as shown in FIG. 24. A shaft 39 is crimped against right and left side plates 32, and torsion coil springs 39a are supported by the shaft 39. The ends of the torsion coil springs 39a are embedded in holes 39b of the right and left side plates 32 so as to be fixed therein. In the absence of the process cartridge 7, torsion coil springs 39a are regulated in a rotation direction by raisings 39c bent from the right and left side plates 32. When the process cartridge 7 is inserted, the torsion coil springs 39a are rotated in a counterclockwise direction against their force. When the torsion coil springs 39a overpass the drum bearing 50, the torsion coil springs 39a are positioned as shown in FIG. 24, and provide a force of about 10 N in a direction indicated by the arrow, thereby positioning the process cartridge 7.

(Embodiment 1)

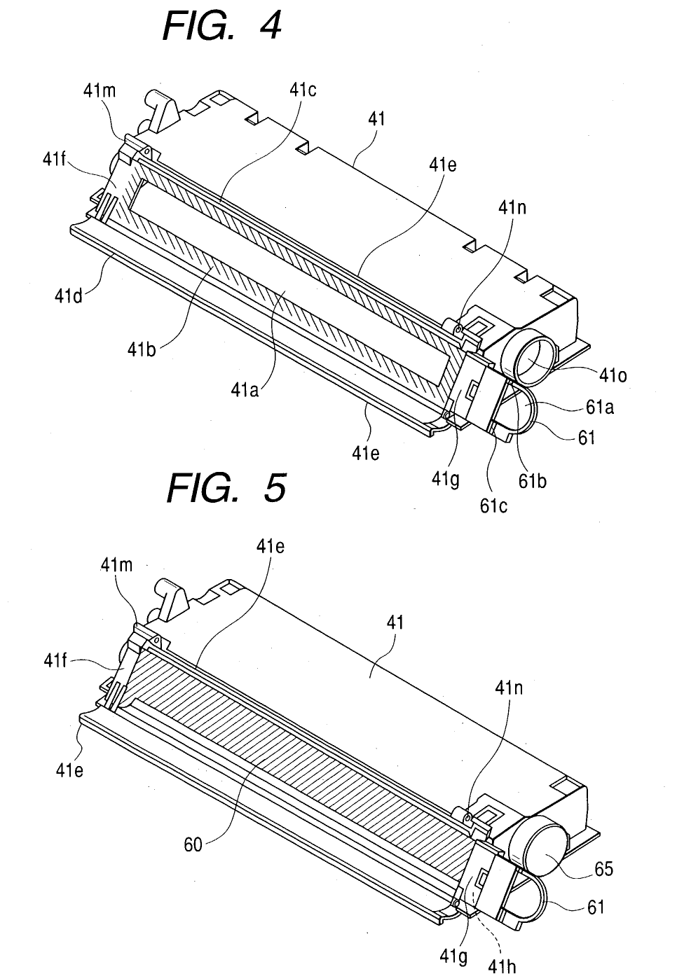

FIGS. 4 through 10, 11A and 11B show a configuration of a connection portion between the toner container 41 and the developing container 45 according to a first embodiment.

As shown in FIG. 4, the toner container 41 (developer container) is provided with an opening 41a that is a developer supply opening for sending toner from the toner container 41 to the developing container 45. On the periphery of the opening 41a, a welding surface 41b for a toner seal 60 (sealing member) described later is provided. Flange portions 41c and 41d are provided at upper and lower edges of the welding surface 41b in a lateral direction, and the flanges 41c and 41d are provided with thread grooves 41e in parallel in a longitudinal direction.

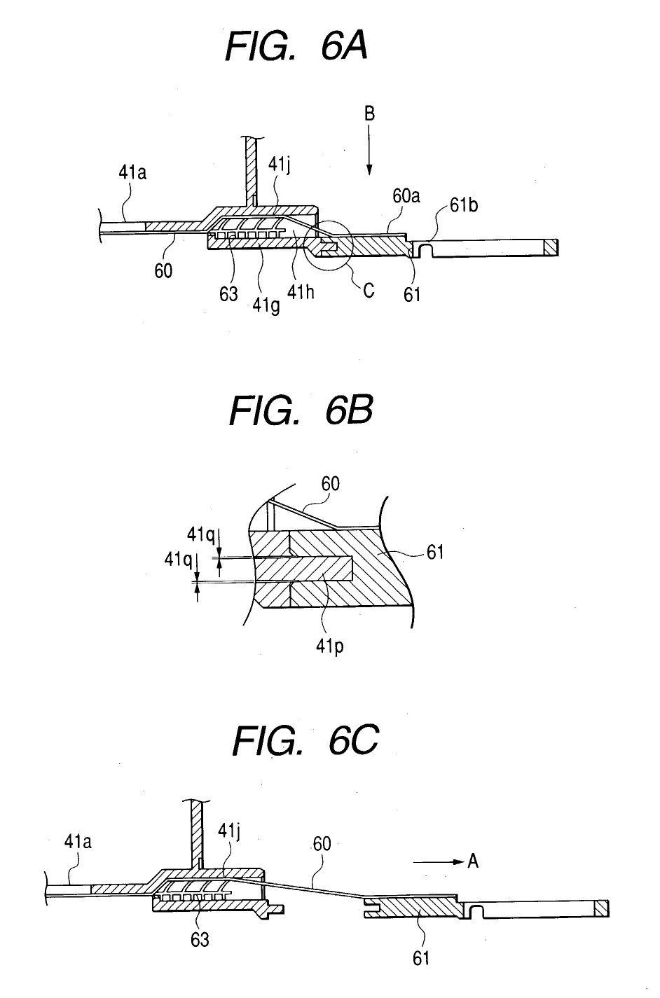

The toner seal 60 shown in FIG. 5 is attached to the welding surface 41b of the toner container 41 so as to cover the opening 41a by welding, bonding, or the like. The toner seal 60 is folded at an end portion 41f of the opening 41a in the longitudinal direction, and is drawn outside through a hollow portion 41h of an end portion 41g on the opposite side in the longitudinal direction, as shown in FIGS. 6A, 6B, and 6C.

A seal grip 61 that is a grip member is integrally molded to the end portion 41g having the hollow portion 41h of the toner container 41. The seal grip 61 is integrally molded to the end portion of the toner container 41 by a resin molding method that is so-called two-color molding using two resin materials, which are easily separable from each other due to their low compatibility and have different colors.

An end portion 60a of the toner seal 60 is attached to the seal grip 61. By pulling the seal grip 61 in the longitudinal direction of the toner container 41, the toner seal 60 can be removed from the toner container 41 (which will be described later in detail).

Furthermore, a cap member 63 made of a material with a satisfactory sliding property and flexibility (e.g., elastomer rubber) is inserted in the hollow portion 41h of the toner container 41. The toner seal 60 is sandwiched between a wall surface 41j of the hollow portion 41h of the toner container 41 and the cap member 63.

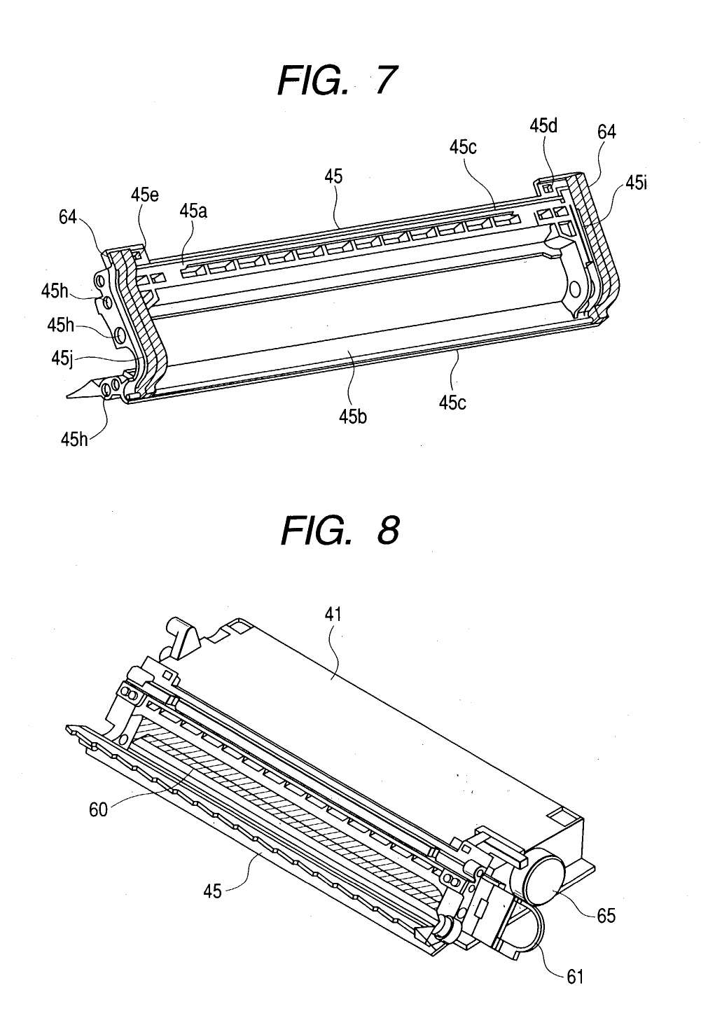

FIG. 7 shows the developing container 45 seen from the direction of the surface to be connected to the toner container 41. As shown in FIG. 7, a protruded thread 45c engaged in the thread groove 41e of the toner container 41 is provided in the longitudinal direction on surfaces 45a and 45b of the developing container 45 opposed to the toner container 41. A triangular protruded thread for ultrasonic welding is provided on the top surface of the protruded thread 45c.

Furthermore, an elastic sealing member 64 such as urethane foam and expanded rubber is attached to end portions 45i and 45j of the developing container 45 in the longitudinal direction of a flat surface opposed to the toner container 41. Alternatively, the end portions 45i and 45j are coated with the elastic sealing member 64. The position of the elastic sealing member 64 is matched with the end portions 41f and 41g of the toner container 41 in the longitudinal direction. The elastic sealing member 64 extends over the entire width in the lateral direction, and is overlapped with the protruded thread 45c. In the present embodiment, the elastic sealing material 64 is attached to the developing container 45. However, it may be provided in the toner container 41.

Furthermore, in order to easily align the toner container 41 with the developing container 45 when connecting them, rectangular bosses 41m and 41n to be fitted into rectangular holes 45d and 45e placed on the developing container 45 are provided on the flange 41c of the toner container 41. Herein, the rectangular hole 45d is tightly fitted onto the rectangular boss 41m, and the rectangular hole 45e is fitted onto the rectangular boss 41n tightly in the lateral direction and roughly in the longitudinal direction.

The toner container 41 and the developing container 45 are connected to each other as follows.

First, the opening 41a of the toner container 41 is sealed with the toner seal 60. Thereafter, toner is placed through a toner filling port 41o, and the toner filling port 41o is sealed with a toner cap 65 (see FIGS. 4 and 5). Thereafter, the rectangular bosses 41m and 41n for positioning the toner container 41 are fitted into the rectangular holes 45d and 45e for positioning the developing container 45 (see FIG. 7). Furthermore, the protruded thread 45c of the developing container 45 is fitted into in the thread groove 41e of the toner container 41.

The toner container 41 and the developing container 45 are pressed to each other, and an ultrasonic vibration is provided between the protruded thread 45c and the thread groove 41e in this state. The rectangular protruded thread provided on the protruded thread 45c is melted by friction heat to be welded to the bottom of the thread groove 41e. Thus, a unit of the toner container 41 and the developing container 45 is completed (see FIG. 8).

In order to send the toner contained in the toner container 41 to the developing container 45 so that the process cartridge 7 is made usable, the seal grip 61 projecting outside of the process cartridge 7 is pulled, whereby the toner seal 60 is drawn out. Because of this, the opening 41a of the toner container 41 is opened, and the toner can be sent from the toner container 41 to the developing container 45, i.e., the usable state of the process cartridge 7 is obtained. At this time, the cap member 63 shown in FIGS. 6A and 6C adheres to the wall surface 41j of the tunnel portion 41j of the toner container 41 after the toner seal 60 is pulled out, thereby preventing the toner from leaking outside.

As the toner seal 60, there is a combination of a cover film for sealing the opening of the toner container and the tear tape for tearing the cover film, in addition to the above-mentioned easy peel type using one folded sheet. The present invention is applicable to any of these toner seals.

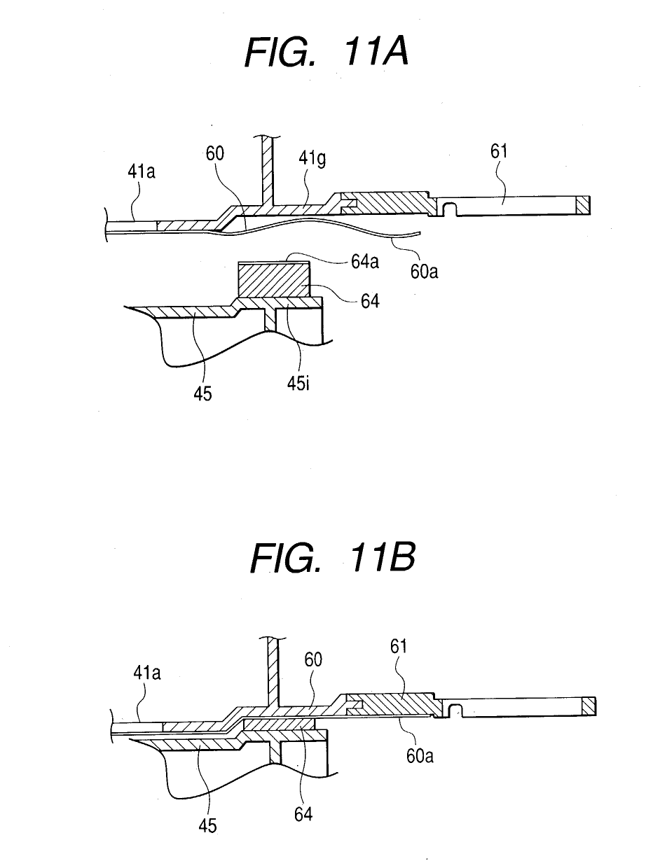

The toner container 41 and the developing container 45 may be connected to each other in the following configuration (see FIGS. 11A and 11B).

As described above, the opening 41a for sending toner from the toner container 41 to the developing container 45 is provided at the connection portion between the toner container 41 and the developing container 45. The welding surface 41b of the toner seal 60 is provided on the periphery of the opening 41a. The flanges 41c and 41d are provided at the upper and lower edges of the welding surface 41b in the lateral direction, and the thread groove 41e is provided at the flange portion in the longitudinal direction.

The protruded thread 45c to be fitted into the thread groove 41e of the toner container 41 is provided on the surfaces 45a and 45b of the developing container 45 opposed to the toner container 41 in the longitudinal direction. The triangular protruded thread for ultrasonic welding is provided at the top surface of the protruded thread 45c.

The elastic sealing member 64 is attached to the end portions 45i and 45j of the developing container 45, and the position thereof in the longitudinal direction is matched with the end portions 41f and 41g of the toner container 41. Furthermore, the elastic sealing member 64 extends over the entire width in the lateral direction and is overlapped with the protruded thread 45c.

The toner seal 60 is attached to the welding surface 41b of the toner container 41 so as to cover the opening 41a by welding, bonding, or the like. One end of the toner seal 60 is folded at one end portion 41f, and the end portion 60a of the toner seal 60 is fixed to the surface side of the seal grip 61 at the other end portion 41g.

First, the opening 41a of the toner container 41 is sealed with the toner seal 60. Thereafter, toner is placed through a toner filling port 41o, and the toner filling port 41o is sealed with a toner cap 65.

Thereafter, the rectangular bosses 41m and 41n for positioning the toner container 41 are engaged in the rectangular holes 45d and 45e for positioning the developing container 45. Furthermore, the protruded thread 45c of the developing container 45 is fitted into the thread groove 41e of the toner container 41. Then, the toner container 41 and the developing container 45 are pressed to each other, whereby the elastic sealing member 64 comes into contact with the end portions 41f and 41g of the toner container 41 in the longitudinal direction to be compressed.

The toner container 41 and the developing container 45 are pressed, and an ultrasonic vibration is provided between the protruded thread 45c and the thread groove 41e in this state. The rectangular protruded thread provided on the protruded thread 45c is melted by friction heat to be welded to the bottom of the thread groove 41e. Thus, the elastic sealing member 64 adheres between the toner container 41 and the developing container 45 as shown in FIG. 11B. When the gap between the toner container 41 and the developing container 45 is sealed, the toner seal 60 is held adhering to a tape 64a attached to the surface of the elastic seal 64. Thus, a unit of the toner container 41 and the developing container 45 is completed in the same way as described above.

In order to send the toner contained in the toner container 41 to the developing container 45 so that the process cartridge 7 is made usable, the seal grip 61 projecting outside of the process cartridge 7 is pulled, whereby the toner seal 60 is drawn out. Because of this, the opening 41a of the toner container 41 is opened, and the toner can be sent from the toner container 41 to the developing container 45, i.e., the usable state of the process cartridge 7 is obtained.

Herein, in the configuration shown in FIGS. 11A and 11B, the elastic sealing member 64 is compressed by the toner container 41 and the developing container 45 while keeping its rectangular cross-section. Therefore, the elastic sealing member 64 has a satisfactory sealing property. Furthermore, the toner seal 60 can be smoothly drawn from between the toner container 41 and the developing container 45 by the tape 64a attached to the surface of the elastic sealing member 64.

In the present embodiment, polystyrene is used as a material for forming the toner container 41 and the developing container 45. However, an ABS resin (acrylonitrile-butadiene-styrene copolymer), polycarbonate, polyethylene, or the like may be used.

Next, the configurations of the toner seal 60 and the seal grip 61 will be described in detail with reference to FIGS. 6A to 6C.

FIG. 6B shows a partially enlarged cross-section of the encircled portion designated by the reference sign C of the seal grip 61 in FIG. 6A. A protruded portion 41p is provided at the end portion 41g of the toner container 41 (developer container main body) in the longitudinal direction. The seal grip 61 is integrally formed by two-color molding using two resin materials having low compatibility, so as to cover the protruded portion 41p by pinching it, embracing it or interdigitating it. Because of this configuration, the seal grip 61 can be separated from the toner container 41 only when being pulled in a direction indicated by the arrow A in FIG. 6C, and the seal grip 61 can resist in a direction indicated by the arrow B in FIG. 6A. Furthermore, an undercut portion 41q is provided at the protruded portion 41p in order for the seal grip 61 not to come off easily by a vibration and a shock during transportation.

As the material for the seal grip 61, a resin material having a shrinkage ratio larger than that of the toner container 41 is used. Due to the shrinkage during molding, the seal grip 61 adheres to the protruded portion 41p of the toner container 41. Because of this, a load capacity with respect to a force from the direction indicated by the arrow B in FIG. 6A can be obtained stably.

In the present embodiment, polypropylene (PP) is used as the material for the seal grip 61. However, there is no particular limit to the above combination, as long as the shrinkage ratio of the material for the seal grip 61 is larger than that of the toner container 41.

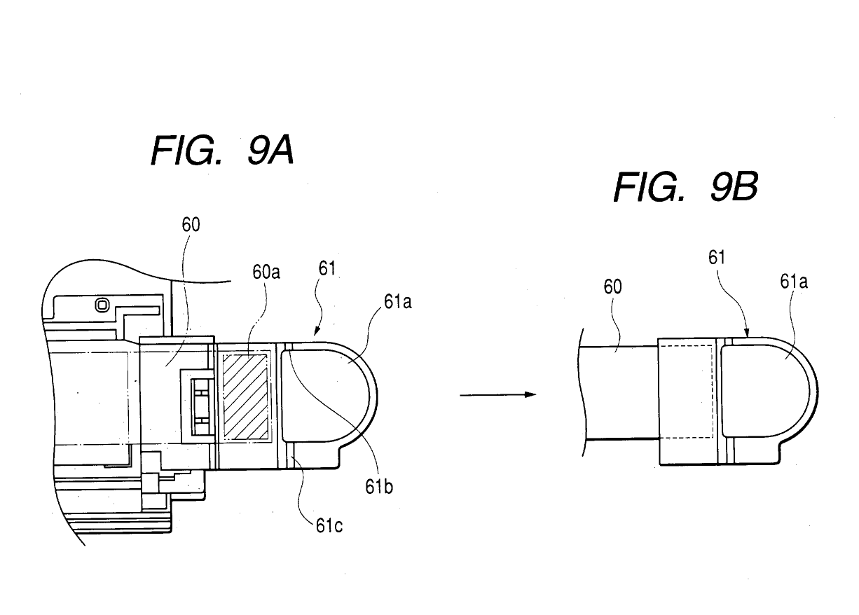

FIGS. 9A and 9B are plan views of the seal grip 61. The end portion 60a of the toner seal 60 is fixed to a region of a reverse surface of the seal grip 61 represented by hatching (FIG. 9A) with a pressure sensitive adhesive double coated tape, welding, or the like. When the seal grip 61 is pulled out in the longitudinal direction of the container, the seal grip 61 is separated from the toner container 41 and the toner seal 60 is opened, as shown in FIG. 9B, whereby the toner in the toner container 41 can be supplied to the developing container 45. The seal grip 61 is provided with a hole 61a for inserting a finger, having a ring shape so as to facilitate a pull operation.

Furthermore, thin portions 61b and 61c are provided in the lateral direction of the seal grip 61. Thus, when the process cartridge 7 is packed for delivering and transportation, the seal grip 61 can be folded from the thin portions 61b and 61c. By designing the seal grip 61 so as to be deformed as described above, a package member can be reduced in dimension without impairing the easiness of pulling the seal grip 61.

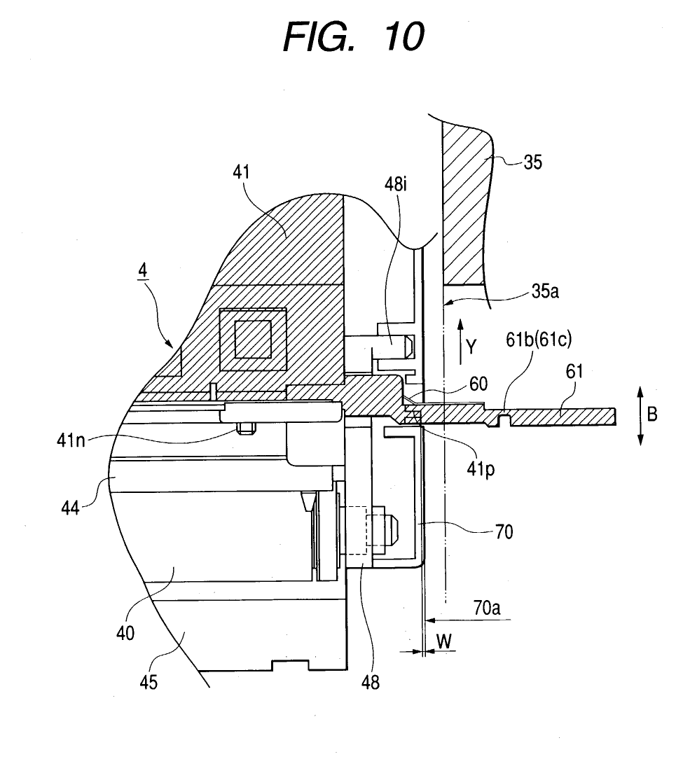

Herein, as shown in FIG. 10, the tip end of the protruded portion 41p of the toner container 41 is substantially matched with the position of an end portion 70a in the longitudinal direction of a side cover 70. Alternatively, the tip end of the protruded portion 41p is placed slightly inside of the container with respect to the end portion 70a in the longitudinal direction via a gap W. Furthermore, the position of the thin portions 61b and 61c of the seal grip 61 is substantially matched with a guide end face 35a in the longitudinal direction of the process cartridge guide 35 of the image forming apparatus or is placed outside in the longitudinal direction of the guide end face 35a. Therefore, when it is attempted to attach the process cartridge 7, with the seal grip 61 attached thereto, to the image forming apparatus main body 30 (when the process cartridge 7 is inserted in a direction indicated by the arrow Y in FIG. 10), the seal grip 61 overpasses the process cartridge mounting region (developer container mounting region) of the image forming apparatus main body 30 to be hitched by the process cartridge guide 35. The seal grip 61 at this time does not come off or is not folded in a direction indicated by the arrow B in FIG. 10. Therefore, the process cartridge 7 cannot be inserted to the apparatus main body any more. Because of this, the process cartridge can be prevented from being mounted to the image forming apparatus main body 30 under the condition that the seal grip 61 is not removed, i.e., the toner has not been supplied from the toner container 41 to the developing container 45 and the process cartridge cannot be used.

On the other hand, under the condition that the seal grip 61 is removed together with the toner seal 60, there is no portion for preventing the mounting of the process cartridge 7 to the image forming apparatus main body 30. Therefore, smooth mounting is made possible.

The tip end position of the protruded portion 41p of the toner container 41 is appropriately varied depending upon the shape of the process cartridge 7 and the shape of the process cartridge guide 35. The same effect can be obtained even if the tip end position is varied.

In the present embodiment, for example, the toner container 41 has a black color and the seal grip 61 has an orange color. The reason for this is to allow a user to easily discriminate the seal grip 61 by setting the main body of the toner container 41 and the seal grip 61 so as to have different colors. The color combination between the main body of the toner container 41 and the seal grip 61 can be arbitrarily determined, and there is no particular limit to the above combination.

Furthermore, even in the container configuration shown in FIGS. 11A and 11B, the toner seal and the seal grip can have the same configuration.

(Embodiment 2)

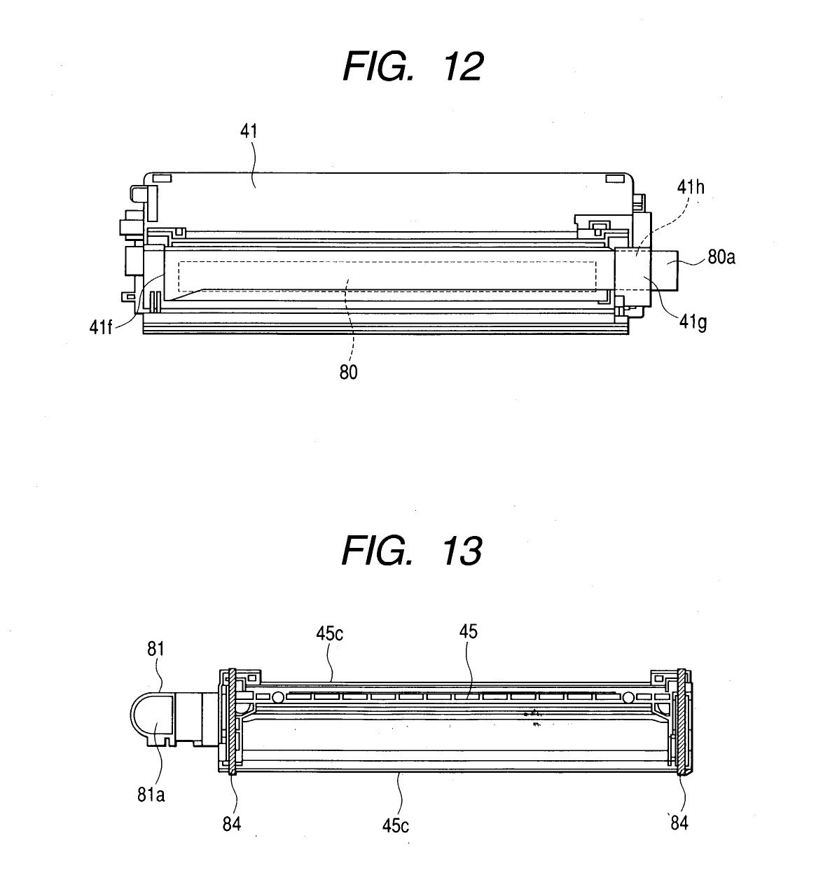

FIGS. 12 to 14 show a second embodiment. The schematic configuration of the image forming apparatus, and the configurations of the process cartridge 7, the image forming apparatus main body 30, the process cartridge guide 35, the toner container 41, the opening 41a, the toner seal welding surface 41b, the flange portions 41c and 41d, the thread groove 41e, the developing container 45, and the like are the same as those in the first embodiment. Therefore, the same components as those in the first embodiment are denoted with the same reference numerals as those therein, and the description thereof will be omitted here.

As shown in FIG. 12, a toner seal 80 is attached to the welding surface 41b so as to seal the opening 41a of the toner container 41 by welding or the like. The toner seal 80 is folded at the end portion 41f of the opening 41a in the longitudinal direction, and thereafter, is drawn outside through the hollow portion 41h of the other end portion 41g of the toner container 41.

Furthermore, a cap member (not shown) made of a material having a satisfactory sliding property and flexibility (for example, elastomer rubber) is inserted to the hollow portion 41h of the toner container 41. The toner seal 80 is sandwiched between the wall surface of the hollow portion 41h of the toner container 41 and the cap member.

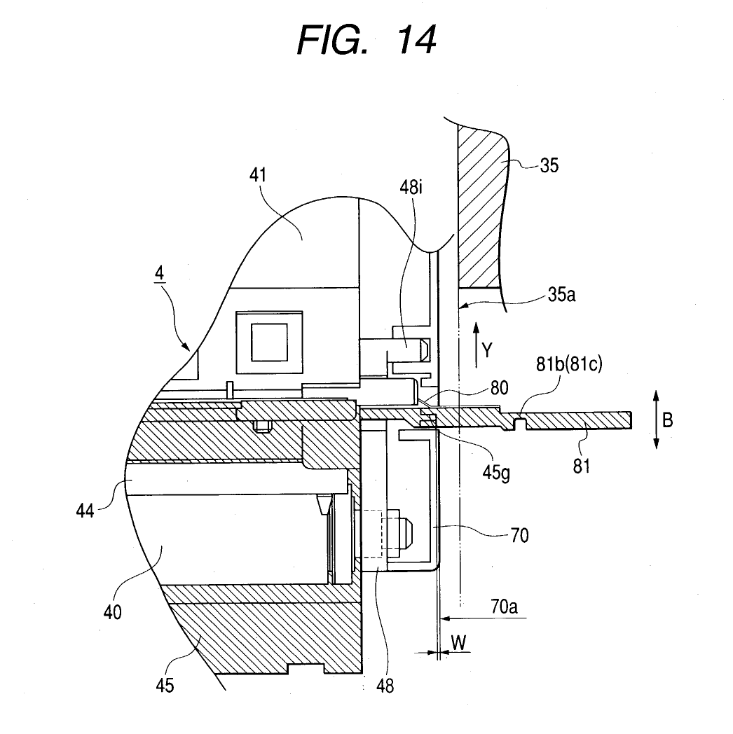

FIG. 13 shows the developing container 45 in a state inverted from the right to the left. A seal grip 81 is integrally molded with the developing container 45 by two-color molding in the same way as in Embodiment 1 at the position of the developing container 45 opposed to a portion from which the toner seal 80 is extended out. More specifically, two-color molding is performed so that the protruded portion 45g is provided at the end portion of the developing container 45 constituting the developing container main body, and the seal grip 81 covers the protruded portion 45g. Furthermore, the same combination as that in the first embodiment is used as the material (see FIG. 14).

An elastic sealing member 84 such as urethane foam and expanded rubber is attached to portions of the developing container 45 opposed to the end portions 41f and 41g of the toner container 41 in the longitudinal direction in the same way as the above. Alternatively, the portions of the developing container 45 are coated with the elastic sealing member 84.

The toner container 41 and the developing container 45 are connected to each other in the same way as in the first embodiment.

The toner container 41 and the developing container 45 are connected to each other. Thereafter, the end portion 80a of the toner seal 80 is fixed to an adjacent region of a hole 81a of the seal grip 81 on the developing container 45 side by a pressure sensitive adhesive double coated tape, welding, or the like. Thus, a unit of the toner container 41 and the developing container 45 is completed.

In the same way as in the first embodiment, as the toner seal 80, there is a combination of a cover film for sealing the opening 41a of the toner container 41 and the tear tape for tearing the cover film, in addition to the above-mentioned easy peel type using one folded sheet. The present invention is applicable to any of these toner seals.

In order to send the toner contained in the toner container 41 to the developing container 45 so that the process cartridge 7 is made usable, the seal grip 81 having a longitudinal dimension extending to the developing container mounting region and the process cartridge mounting region of the image forming apparatus and projecting outside of the process cartridge 7 is pulled, whereby the toner seal 80 is drawn out. Because of this, the opening 41a of the toner container 41 is opened, and the toner can be sent from the toner container 41 to the developing container 45, i.e., the usable state of the process cartridge 7 is obtained. At this time, the cap member (not shown) adheres to the wall surface of the hollow portion 41h of the toner container 41 after the toner seal is pulled out, thereby preventing the toner from leaking outside.

In the present embodiment, polystyrene is used as a material for the developing container 45. However, an ABS resin (acrylonitrile-butadiene-styrene copolymer), polycarbonate, polyethylene, or the like may be used. Furthermore, polypropylene (PP) is used as the material for the seal grip 81. The same effect can be obtained as long as the material having a shrinkage ratio during molding larger than that of the main body of the developing container 45, as described above. Therefore, there is no particular limit to the above combination. Furthermore, the shape of the seal grip 81 is the same as that in the first embodiment.

Furthermore, the configuration of the opposed surface of the toner container 41 and the developing container 45 may be the same as that in FIGS. 11A and 11B.

Herein, as shown in FIG. 14, the tip end of the protruded portion 45g of the developing container 45 is substantially matched with an end portion 70a in the longitudinal direction of a side cover 70. Alternatively, the tip end of the protruded portion 41p is placed slightly inside of the container with respect to the end portion 70a in the longitudinal direction via a gap W. Furthermore, the position of the thin portions 81b and 81c of the seal grip 81 is substantially matched with a guide end face 35a in the longitudinal direction of the process cartridge guide 35 of the image forming apparatus or is placed outside in the longitudinal direction of the guide end face 35a. Therefore, when it is attempted to mount the process cartridge 7, with the seal grip 81 attached thereto, to the image forming apparatus main body 30 (when the process cartridge 7 is inserted in a direction indicated by the arrow Y in FIG. 14), the seal grip 81 is hitched by the process cartridge guide 35. The seal grip 81 at this time does not come off in a direction indicated by the arrow B in FIG. 14. Therefore, the process cartridge 7 cannot be inserted to the apparatus main body any more. Because of this, the process cartridge can be prevented from being mounted to the image forming apparatus main body 30 under the condition that the seal grip 81 is not removed, i.e., the toner has not been supplied from the toner container 41 to the developing container 45 and the process cartridge cannot be used.

On the other hand, under the condition that the seal grip 81 is removed, there is no portion for preventing the mounting of the process cartridge 7 to the image forming apparatus main body 30. Therefore, smooth mounting is made possible.

The tip end position of the protruded portion 45g of the developing container 45 is appropriately varied depending upon the shape of the process cartridge 7 and the shape of the process cartridge guide 35. The same effect can be obtained even if the tip end position is varied.

In the same way as in the first embodiment, the color combination between the main body of the developing container 45 and the seal grip 81 can be arbitrarily determined, and there is no particular limit to the above combination.

(Embodiment 3)

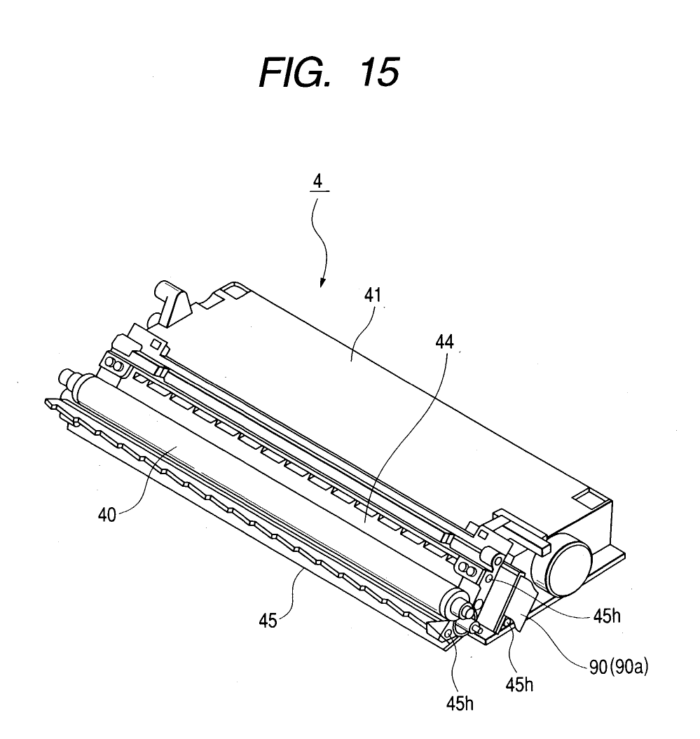

FIGS. 15 to 17 show a third embodiment. The schematic configuration of the image forming apparatus, and the configurations of the process cartridge 7, the image forming apparatus main body 30, the process cartridge guide 35, the toner container 41, the developing container 45, the developing blade 44, the developing roller 40, the bearing member 48, and the like are the same as those in the first embodiment. Therefore, the same components as those in the first embodiment are denoted with the same reference numerals as those therein, and the description thereof will be omitted here.

In the same way as in the first embodiment, a toner seal 90 is attached to the welding surface of the toner seal so as to seal the opening 41 of the toner container 41 by welding or the like. The toner seal 90 is folded at the end portion of the opening in the longitudinal direction, and is extended outside through the hollow portion of the other end portion of the toner container 41.

Furthermore, a cap member made of a material having a satisfactory sliding property and flexibility (for example, elastomer rubber) is inserted to the hollow portion of the toner container 41. The toner seal 90 is sandwiched between the wall surface of the hollow portion of the toner container 41 and the cap member.

Furthermore, an elastic sealing member such as urethane foam and expanded rubber is attached to end portions of the developing container 45 in the longitudinal direction of a flat surface opposed to the toner container 41. Alternatively, the end portions are coated with the elastic sealing member. The position of the elastic sealing member is matched with the end portions of the toner container 41 in the longitudinal direction. The elastic sealing member extends over the entire width in the lateral direction, and is overlapped with the protruded thread.

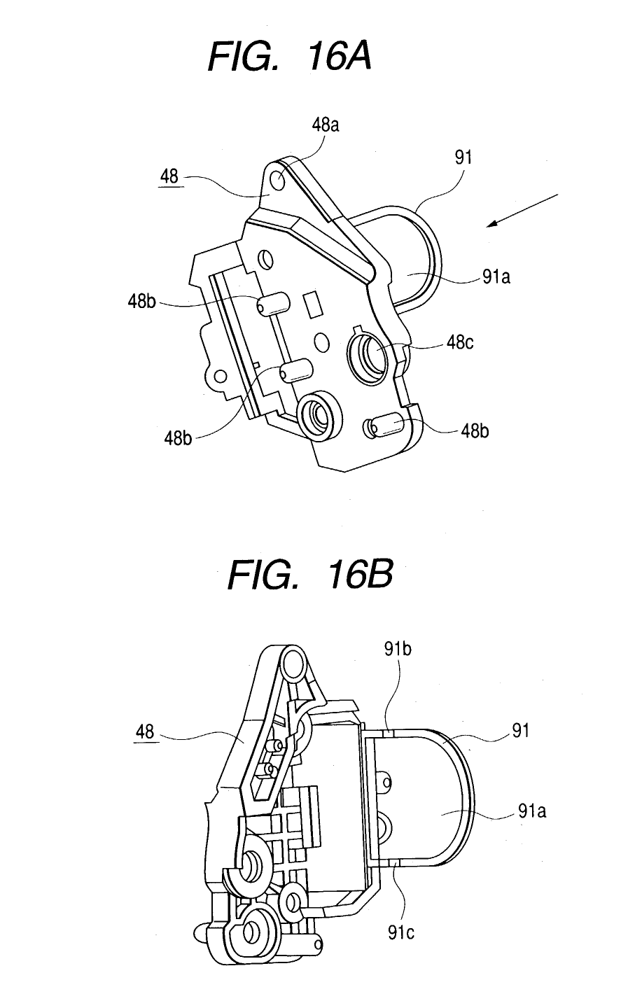

FIGS. 16A and 16B show a configuration of a bearing including one bearing member 48 for rotatably supporting the developing roller 40. The bearing member 48 is provided with a connection portion 48a with respect to the photosensitive drum unit, a boss 48b for positioning with respect to the developing container 45, and a bearing portion 48c for rotatably supporting the developing roller 40 (developer bearing member).

As shown in FIG. 15, the developing blade 44 and the like are previously incorporated into the developing container 45. Under this condition, a positioning hole 45h of the developing container 45 is fitted onto a positioning boss 48b of the bearing member 48 while the developing roller 40 is aligned with the bearing portion 48c of the bearing member 48, whereby the developing container 45 is fixed with a screw.

As shown in FIGS. 16A and 16B, a seal grip 91 is integrally molded with a portion of the bearing member 48 positioned in the vicinity of an end portion 90a of a toner seal 90. After the bearing member 48 is incorporated into the developing container 45, the end portion 90a of the toner seal 90 is fixed by a fixing method such as a pressure sensitive adhesive double coated tape, welding, or the like, whereby incorporation of the toner seal 90 into the seal grip 91 is completed.

The configuration of the toner seal 90 is the same as that of the first embodiment.

In order to send the toner contained in the toner container 41 to the developing container 45 so that the process cartridge 7 is made usable, the seal grip 91 projecting outside of the process cartridge 7 is pulled, whereby the toner seal 90 is drawn out. Because of this, the opening of the toner container 41 is opened, and the toner can be sent from the toner container 41 to the developing container 45, i.e., the usable state of the process cartridge 7 is obtained.

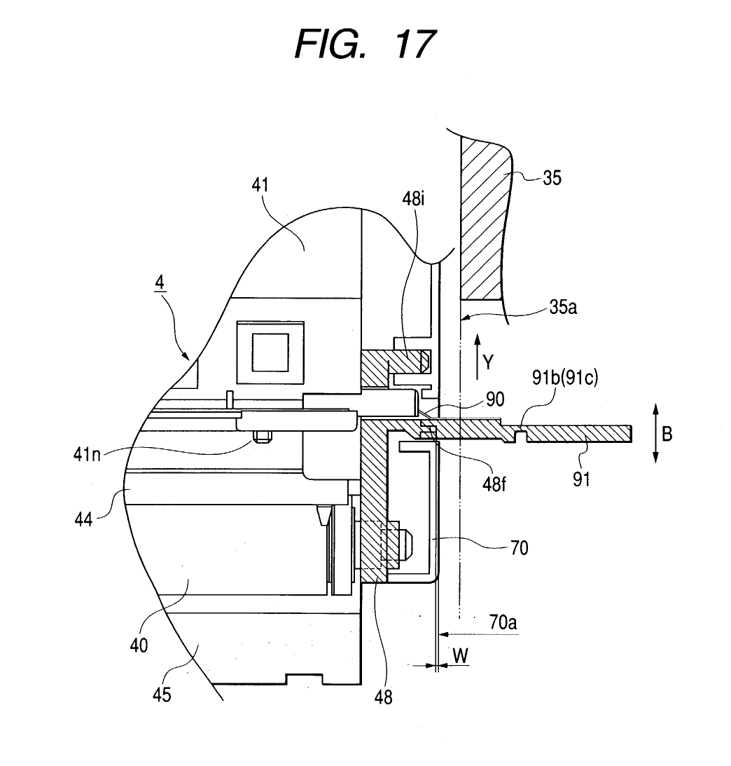

Herein, as the material for the seal grip 61, a material having a shrinkage ratio larger than that of the bearing member 48 is used. Due to the shrinkage during molding, the seal grip 91 adheres to the protruded portion 48f (see FIG. 17) of the bearing member 48. Because of this, a load capacity with respect to a force from the direction indicated by the arrow B in FIG. 17 can be obtained stably.

In the present embodiment, polycarbonate (PC) or polystyrene (PS) is used as the material for the bearing member 48, and polypropylene (PP) is used as the material for the seal grip 91. However, there is no particular limit to the above combination, as long as the shrinkage ratio of the material for the seal grip 91 is larger than that of the bearing member 48.

Furthermore, the configuration of the opposed surface of the toner container 41 and the developing container 45 may be the same as that in FIGS. 11A and 11B.

Herein, as shown in FIG. 17, the tip end of the protruded portion 48f of the bearing member 48 is substantially matched with an end portion 70a in the longitudinal direction of a side cover 70. Alternatively, the tip end of the protruded portion 48f is placed slightly inside of the container with respect to the end portion 70a in the longitudinal direction via a gap W. Furthermore, the position of the thin portions 91b and 91c of the seal grip 91 is substantially matched with a guide end face 35a in the longitudinal direction of the process cartridge guide 35 of the image forming apparatus 30 or is placed outside in the longitudinal direction of the guide end face 35a. Therefore, when it is attempted to mount the process cartridge 7, with the seal grip 91 attached thereto, to the image forming apparatus main body 30 (when the process cartridge 7 is inserted in a direction indicated by the arrow Y in FIG. 17), the seal grip 91 is hitched by the process cartridge guide 35. The seal grip 91 at this time does not come off in a direction indicated by the arrow B in FIG. 17. Therefore, the process cartridge 7 cannot be inserted to the apparatus main body any more. Because of this, the process cartridge can be prevented from being mounted to the image forming apparatus main body 30 under the condition that the seal grip 91 is not removed, i.e., the toner has not been supplied from the toner container 41 to the developing container 45 and the process cartridge cannot be used.

On the other hand, under the condition that the seal grip 91 is removed, there is no portion for preventing the mounting of the process cartridge 7 to the image forming apparatus main body 30. Therefore, smooth mounting is made possible.

The tip end position of the protruded portion 48f of the bearing member 48 is appropriately varied depending upon the shape of the process cartridge 7 and the shape of the process cartridge guide 35. The same effect can be obtained even if the tip end position is varied.

In the present embodiment, the toner container 41, the developing container 45, the side cover 70, and the bearing member 48, constituting the developing device main body, have a black color. However, the seal grip 91 provided at the bearing member 48 has an orange color. The reason for this is to allow a user to easily discriminate the seal grip 91 by setting the developing device main body and the seal grip 91 so as to have different colors. The color combination among the toner container 41, the developing container 45, the side cover 70, the bearing member 48, and the seal grip 91 constituting the developing device can be arbitrarily determined, and there is no particular limit to the above combination.

(Embodiment 4)

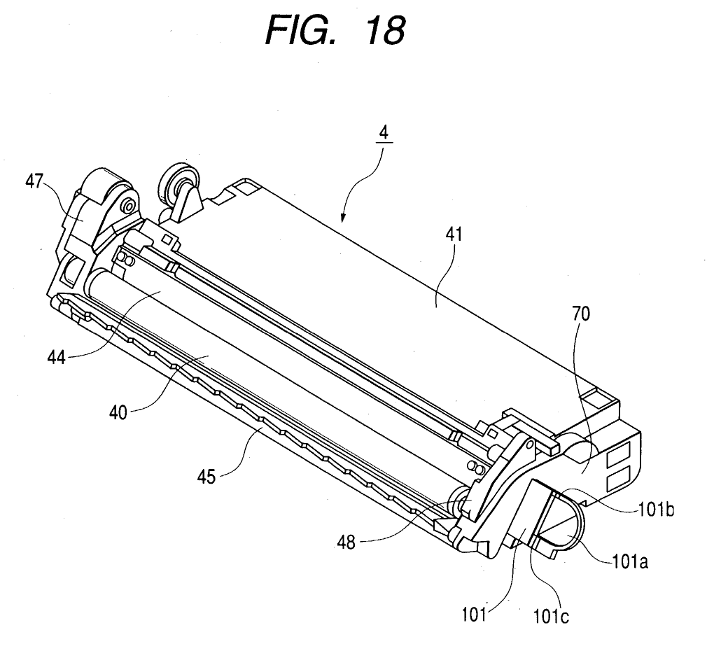

FIGS. 18 to 21 show a fourth embodiment. The schematic configuration of the image forming apparatus, and the configurations of the process cartridge 7, the image forming apparatus main body 30, the process cartridge guide 35, the toner container 41, the developing container 45, the side cover 70, and the like are the same as those in the first embodiment. Therefore, the same components as those in the first embodiment are denoted with the same reference numerals as those therein, and the description thereof will be omitted here.

Furthermore, the attachment and handling of a toner seal 100, and the connection procedure of the toner container 41 and the developing container 45 shown in FIG. 21 are the same as those in the first embodiment.

A method for attaching the bearing member 48 and the side cover 70 to the developing container 45 will be described. As shown in FIGS. 20A and 20B, the bearing member 48 of the present embodiment is provided with the connection portion 48a with respect to the photosensitive drum unit, the boss 48b for positioning with respect to the developing container 45, and the bearing portion 48c for rotatably supporting the developing roller 40.

Furthermore, the developing blade 44 and the like are previously incorporated into the developing container 45. Under this condition, the positioning hole of the developing container 45 is fitted onto the positioning boss 48b of the bearing member 48 while the developing roller 40 is aligned with the bearing portion 48c of the bearing member 48, whereby the developing container 45 is fixed with a screw. At this time, the end portion of the toner seal 100 is passed through a rectangular hole 48h provided in the bearing member 48.

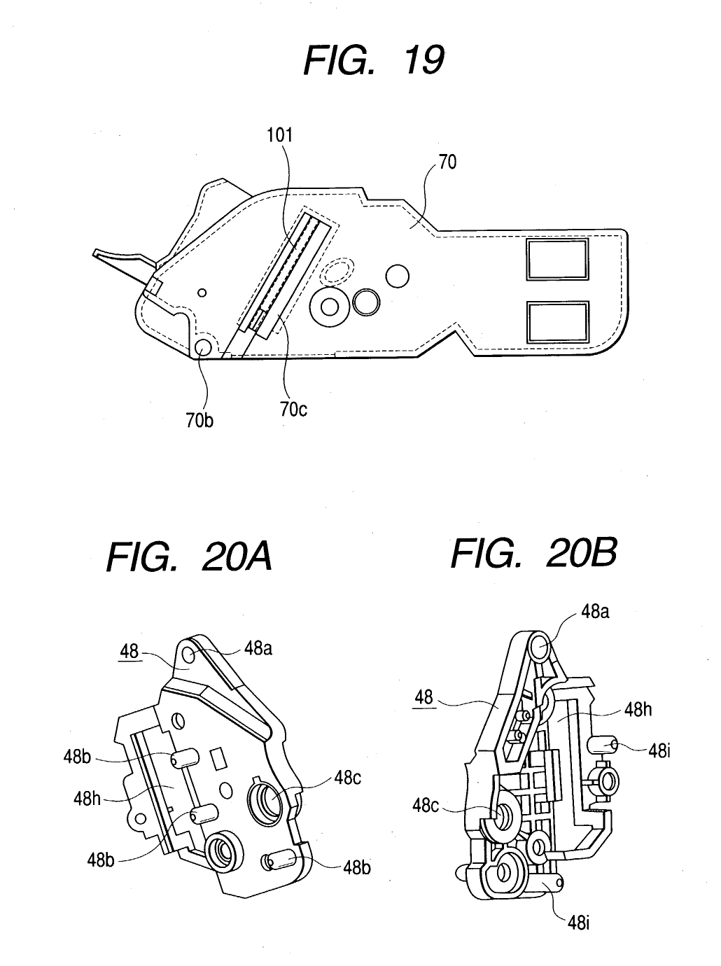

The side cover 70 is attached to the bearing member 48 with a screw under the condition that the positioning boss 48i of the bearing member 48 is aligned with the positioning hole 70b of the side cover 70, as shown in FIG. 21, after the bearing member 48 is attached to the developing container 45. At this time, the end portion of the toner seal 100 is passed through the rectangular hole 70c provided on the side cover 70 (see FIG. 19).

Herein, a seal grip 101 is provided integrally with the side cover 70 in the vicinity of the end portion of the toner seal 100. After the side cover 70 is incorporated into the bearing member 48, the end portion of the toner seal 100 is fixed to the seal grip 101 by a fixing method such as a pressure sensitive adhesive double coated tape, welding, or the like, whereby incorporation of the toner seal 100 into the seal grip 101 is completed.

The configuration of the toner seal 100 is the same as that of the first embodiment.

In order to send the toner contained in the toner container 41 to the developing container 45 so that the process cartridge 7 is made usable, the seal grip 101 projecting outside of the process cartridge 7 is pulled, whereby the toner seal 100 is drawn out. Because of this, the opening of the toner container 41 is opened, and the toner can be sent from the toner container 41 to the developing container 45, i.e., the usable state of the process cartridge 7 is obtained.

Herein, as the material for the seal grip 101, a material having a shrinkage ratio larger than that of the main body of the side cover 70 is used. Due to the shrinkage during molding, the seal grip 101 shown in FIG. 21 adheres to the protruded portion 70d of the side cover 70. Because of this, a load capacity with respect to a force from the direction indicated by the arrow B in FIG. 21 can be obtained stably. In the present embodiment, polystyrene (PS) is used as the material for the side cover 70, and polypropylene (PP) is used as the material for the seal grip 101. However, there is no particular limit to the above combination, as long as the shrinkage ratio of the material for the seal grip 101 is larger than that of the main body of the side cover 70.

Furthermore, the configuration of the opposed surface of the toner container 41 and the developing container 45 may be the same as that in FIGS. 11A and 11B.

Herein, as shown in FIG. 21, the tip end of the protruded portion 70d of the side cover 70 is substantially matched with an end portion 70a in the longitudinal direction of a side cover 70. Alternatively, the tip end of the protruded portion 70d is placed slightly inside of the container with respect to the end portion 70a in the longitudinal direction via a gap W. Furthermore, the position of the thin portions 101b and 101c of the seal grip 101 in the longitudinal direction is substantially matched with a guide end face 35a in the longitudinal direction of the process cartridge guide 35 of the image forming apparatus main body 30 or is placed outside in the longitudinal direction of the guide end face 35a. Therefore, when it is attempted to mount the process cartridge 7, with the seal grip 101 attached thereto, to the image forming apparatus main body 30 (when the process cartridge 7 is inserted in a direction indicated by the arrow Y in FIG. 21), the seal grip 101 is hitched by the process cartridge guide 35. The seal grip 101 at this time does not come off in a direction indicated by the arrow B in FIG. 21. Therefore, the process cartridge 7 cannot be inserted to the apparatus main body any more. Because of this, the process cartridge can be prevented from being attached to the image forming apparatus main body 30 under the condition that the seal grip 101 is not removed, i.e., the toner has not been supplied from the toner container 41 to the developing container 45 and the process cartridge cannot be used.

On the other hand, under the condition that the seal grip 101 is removed, there is no portion for preventing the mounting of the process cartridge 7 to the image forming apparatus main body 30. Therefore, smooth mounting is made possible.

The tip end position of the protruded portion 70d of the side cover 70 is appropriately varied depending upon the shape of the process cartridge 7 and the shape of the process cartridge guide 35. The same effect can be obtained even if the tip end position is varied.

In the present embodiment, the toner container 41, the developing container 45, the bearing member 48, and the main body of the side cover 70, constituting the developing device main body, have a black color. However, the seal grip 101 provided at the side cover 70 has an orange color. The reason for this is to allow a user to easily discriminate the seal grip 101 by setting the developing device main body and the seal grip 101 so as to have different colors. The color combination among the toner container 41, the developing container 45, the bearing member 48, the side cover 70, and the seal grip 101 constituting the developing device main body can be arbitrarily determined, and there is no particular limit to the above combination.

(Embodiment 5)

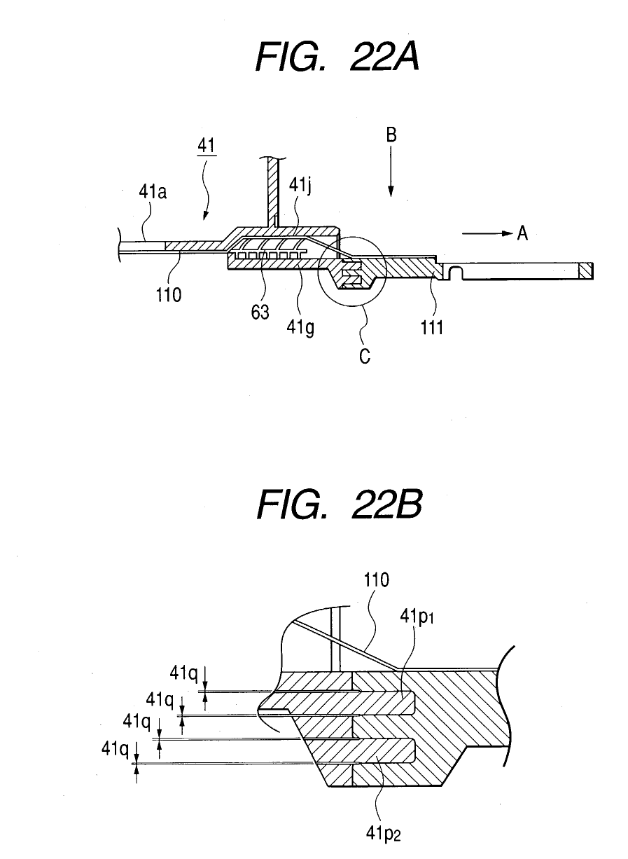

FIGS. 22A and 22B show a fifth embodiment. The configurations of the toner container 41, the opening 41a, the cap member 63, and the like are the same as those in the first embodiment. Therefore, the description thereof will be omitted here.

FIG. 22B shows a partially enlarged view of a seal grip 111 with the end portion of the toner seal 110 connected thereto according the present embodiment. As shown in FIG. 22B, plural protruded portions 41p1 and 42p2 similar to the protruded portion 41p of the toner container 41 shown in FIGS. 6A, 6B, and 6C are arranged, and a seal grip 111 is integrally molded by two-color molding so as to cover the protruded portions 41p1 and 42p2.

Because of this configuration, the seal grip 111 can be separated from the toner container 41 only when being pulled in a direction indicated by the arrow A in FIG. 22A, and can resist in a direction indicated by the arrow B in FIG. 22A with a large force. Furthermore, the undercut portions 41q are provided at the respective protruded portions 41p1 and 41p2, whereby the seal grip 111 is prevented from easily coming off due to the vibration and a shock during transportation or the like.

Further, as the material for the seal grip 111, a material having a shrinkage ratio larger than that of the toner container 41 is used. Due to the shrinkage during molding, the seal grip 111 adheres to the protruded portions 41p1 and 41p2 of the toner container 41. Because of this, a load capacity with respect to a force from the direction indicated by the arrow B in FIG. 22A can be obtained stably.

In the present embodiment, polypropylene (PP) is used as the material for the seal grip 111. However, there is no particular limit to the above combination, as long as the shrinkage ratio of the material for the seal grip 111 is larger than that of the toner container 41.

The present embodiment is applicable not only to the case where the seal grip 111 is provided at the toner container 41 as shown in FIG. 22A, but also to the case where the seal grip 81 is provided at the developing container 45 described in Embodiment 2, the case where the seal grip 91 is provided at the bearing member 48 as described in Embodiment 3, or the case where the seal grip 101 is provided at the side cover 70 as described in Embodiment 4.

According to the above-mentioned embodiment, the developer supply opening of the developing container is sealed with a sealing member so that a developer does not leak before the process cartridge is mounted to the image forming apparatus main body. Immediately before the process cartridge is mounted to the image forming apparatus main body, the grip member connected to one end of the sealing member is pulled in the longitudinal direction to open the sealing member, whereby the developer can be supplied from the developer container to the developing container.

The grip member of the sealing member is integrally molded so as to be separable, using a resin material having low compatibility with respect to the developer container, the developing container, the bearing member of the developing roller of the developing device, the side cover, and the like. The grip member is separated from the developer container main body and the like by a pull operation of the grip member for pulling out the sealing member. The sealing member is designed so as to be drawn out in the longitudinal direction. Accordingly, the number of components can be reduced, and the production processes can be simplified without impairing the efficiency of the operation of removing a sealing member.

Furthermore, the grip member of the sealing member having a different color from that of the developer container and the like can be simultaneously molded by so-called two-color molding. Therefore, the process of producing the grip member discriminable by the color as a separate component can be omitted. Thus, the cost of the image forming apparatus can be greatly reduced by the reduction in number of production processes.

Furthermore, the outer dimension of the grip member extends outside of the developer container in the longitudinal direction. The process cartridge cannot be mounted to the image forming apparatus unless the developer supply opening is opened by pulling the grip member. Therefore, an operation error of mounting the process cartridge without opening the developer supply opening can be prevented, and damage and the like caused by the carelessness of a user can be avoided.

As described above, the opening of the toner container is sealed with the toner seal; the seal grip is pulled out at the commencement of use to pull out the toner seal in the longitudinal direction of the process cartridge. Furthermore, the seal grip is placed so as to be outside of the width of a guide in the longitudinal direction of the process cartridge, which guide is for mounting/detaching the process cartridge to the image forming apparatus main body. Thus, the process cartridge can be prevented from being mounted to the image forming apparatus main body under the condition that the seal grip is not removed. Furthermore, the toner container, the developing container, the bearing member or the side cover, and the seal grip are integrally molded by two-color molding with materials having low compatibility. Thus, while the number of components and the number of assembly processes are reduced, the dimension of the engagement portion between the toner container, the developing container, the bearing member or the side cover, and the seal grip can be obtained stably. Therefore, the seal grip can be prevented from coming off due to the vibration during transportation, while the force of pulling the seal grip is reduced. Furthermore, by subjecting the seal grip to two-color molding, the color of the seal grip can be arbitrarily set, and a user can easily discriminate the portion to be removed with a color when using the process cartridge.

According to the present invention, the number of components can be reduced. Furthermore, according to the present invention, the process cartridge cannot be mounted to the image forming apparatus main body unless the seal grip is removed, whereby mounting operability is enhanced.

While the invention has been described with reference to the structure disclosed herein, it is not confined to the details set forth and this application is intended to cover such modifications or changes as may come within the purposes of the improvements or the scope of the following claims.

What is claimed is:

1. A developer container of a developing device to be mounted to an image forming apparatus, the developer container comprising:
a developer container main body provided with a developer containing for containing a developer and a developer supply opening;
a sealing member that seals the developer supply opening of the developer container main body; and
a grip member for pulling out the sealing member in a longitudinal direction of the developer container main body,
wherein the developer container main body and the grip member are integrally molded from resin materials having low compatibility to be separable from each other, and
the grip member has a longitudinal dimension extending to an outside of a developer container mounting region of the image forming apparatus.

2. A developer container according to claim 1, wherein the resin material forming the grip member has a shrinkage ratio larger than that of the resin material forming the developer container main body.

3. A developer container according to claim 1 or 2, wherein the developer container main body is provided with a protruded portion to be pinched by or interdigitated with the grip member.

4. A developer container according to claim 3, wherein an undercut is provided in the protruded portion of the developer container main body.

5. A developer container according to claim 4, wherein a plurality of the protruded portions are arranged on the developer container main body.

6. A developer container according to claim 5, wherein the developer container main body and the grip member are two-color molded from two resin materials having different colors.

7. A developer container according to claim 6, wherein the grip member has a ring shape.

8. A developer container according to claim 7, wherein the grip member has a thin portion for allowing easy deformation thereof.

9. A developing device comprising a developer container as set forth in claim 1.

10. A process cartridge comprising:
a developing device having a developer container as set forth in claim 1; and
an electrophotographic photosensitive member.

11. A process cartridge comprising:
a developing device having a developer container as set forth in claim 1; and
an electrophotographic photosensitive member, wherein a longitudinal dimension of a grip member extends to an outside of a process cartridge mounting region of an image forming apparatus.

12. An image forming apparatus comprising an image forming apparatus main body to which a developing device having a developer container as set forth in claim 1 and an electrophotographic photosensitive member are mounted.

13. An image forming apparatus comprising:
a process cartridge including a developer container as set forth in claim 1, an electrophotographic photosensitive member, and a process means acting on the electrophotographic photosensitive member; and
an image forming apparatus main body to which the process cartridge is mounted.

14. An image forming apparatus comprising:
a developer container as set forth in claim 1;
an electrophotographic photosensitive member; and
an image forming apparatus main body to which the developer container and the electrophotographic photosensitive member are mounted.

15. A developing container to be connected to a developer container that includes: a developer containing portion for containing a developer, a developer supply opening, and a sealing member that seals the developer supply opening, the developing container comprising:
a developer bearing member for acting on an electrophotographic photosensitive member of an image forming apparatus;
a developing container main body that supports the developer bearing member; and
a grip member for pulling out the sealing member in a longitudinal direction of the developer container,
wherein the developing container main body and the grip member are integrally molded from resin materials having low compatibility to be separable from each other, and
the grip member has a longitudinal dimension extending to an outside of a developing container mounting region of the image forming apparatus.

16. A developing container according to claim 15, wherein the resin material forming the grip member has a shrinkage ratio larger than that of the resin material forming the developing container main body.

17. A developing container according to claim 15 or 16, wherein the developing container main body is provided with a protruded portion to be pinched by or interdigitated with the grip member.

18. A developing container according to claim 17, wherein an undercut is provided in the protruded portion of the developing container main body.

19. A developing container according to claim 18, wherein a plurality of the protruded portions are arranged on the developing container main body.

20. A developing container according to claim 19, wherein the developing container main body and the grip member are two-color molded from two resin materials having different colors.

21. A developing container according to claim 20, wherein the grip member has a ring shape.

22. A developing container according to claim 21, wherein the grip member has a thin portion for allowing easy deformation thereof.

23. A developing device comprising a developing container as set forth in claim 15.

24. A process cartridge comprising:
a developing device having a developing container as set forth in claim 15; and an electrophotographic photosensitive member.

25. A process cartridge comprising:
a developing device having a developing container as set forth in claim 15; and
an electrophotographic photosensitive member, wherein a longitudinal dimension of a grip member extends to an outside of a process cartridge mounting region of an image forming apparatus.

26. An image forming apparatus comprising:
a developing device having a developing container as set forth in claim 15;
an electrophotographic photosensitive member; and
an image forming apparatus main body to which the electrophotographic photosensitive member and the developing device are mounted.

27. An image forming apparatus comprising:
a process cartridge including a developing device having a developing container as set forth in claim 15, and an electrophotographic photosensitive member; and
an image forming apparatus main body to which the process cartridge is mounted.

28. A bearing structure of a developing device that is provided with: a developer container having a developer containing portion that contains a developer, a developer supply opening, and a sealing member that seals the developer supply opening, and a developer bearing member for acting on an electrophotographic photosensitive member of an image forming apparatus, the bearing structure comprising:
a bearing member that rotatably supports the developer bearing member; and
a grip member for pulling out the sealing member in a longitudinal direction of the developer container,
wherein the bearing member and the grip member are integrally molded from resin materials having low compatibility to be separable from each other, and
the grip member has a longitudinal dimension extending to an outside of a developing device mounting region of the image forming apparatus.

29. A bearing structure according to claim 28, wherein the resin material forming the grip member has a shrinkage ratio larger than that of the resin material forming the bearing member.

30. A bearing structure according to claim 28 or 29, wherein the bearing member is provided with a protruded portion pinched by or interdigitated with the grip member.

31. A bearing structure according to claim 30, wherein an undercut is provided in the protruded portion of the bearing member.

32. A bearing structure according to claim 31, wherein a plurality of the protruded portions are arranged on the bearing member.

33. A bearing structure according to claim 32, wherein the bearing member and the grip member are two-color molded from two resin materials having different colors.

34. A bearing structure according to claim 33, wherein the grip member has a ring shape.

35. A bearing structure according to claim 34, wherein the grip member has a thin portion for allowing easy deformation thereof.

36. A developing device comprising a bearing structure as set forth in claim 28.

37. A process cartridge comprising:
a developing device having a bearing structure as set forth in claim 28; and
an electrophotographic photosensitive member.

38. A process cartridge comprising:
a developing device having a bearing structure as set forth in claim 28; and
an electrophotographic photosensitive member, wherein a longitudinal dimension of the grip member extends to an outside of a process cartridge mounting region of an image forming apparatus.

39. An image forming apparatus comprising:
a developing device having a bearing structure as set forth in claim 28;
an electrophotographic photosensitive member; and
an image forming apparatus main body to which the electrophotographic photosensitive member and the developing device are mounted.

40. An image forming apparatus comprising:
a process cartridge including a developing device having a bearing structure as set forth in claim 28, and an electrophotographic photosensitive member; and
an image forming apparatus main body to which the process cartridge is mounted.

41. A side cover of a developing device having a developer container that includes: a developer containing portion for containing a developer, a developer supply opening; and a sealing member that seals the developer supply opening, the side cover comprising:
a side cover main body connected to a side surface of the developer container; and
a grip member for pulling out the sealing member in a longitudinal direction of the developer container,
wherein the side cover main body and the grip member are integrally molded from resin materials having low compatibility to be separable from each other, and
the grip member has a longitudinal dimension extending to an outside of a developing device mounting region of the image forming apparatus.

42. A side cover according to claim 41, wherein the resin material forming the grip member has a shrinkage ratio larger than that of the resin material forming the side cover main body.

43. A side cover according to claim 41 or 42, wherein the side cover main body is provided with a protruded portion pinched by or interdigitated with the grip member.

44. A side cover according to claim 43, wherein an undercut portion is provided in the protruded portion of the side cover main body.

45. A side cover according to claim 44, wherein a plurality of protruded portions are arranged on the side cover main body.

46. A side cover according to claim 45, wherein the side cover main body and the grip member are two-color molded from two resin materials having different colors.

47. A side cover according to claim 46, wherein the grip member has a ring shape.

48. A side cover according to claim 47, wherein the grip member has a thin portion for allowing easy deformation thereof.

49. A developing device comprising a side cover as set forth in claim 41.

50. A process cartridge comprising:
a developing device having a side cover as set forth in claim 41; and
an electrophotographic photosensitive member.

51. A process cartridge comprising:
a developing device having a side cover as set forth in claim 41; and
an electrophotographic photosensitive member, wherein a longitudinal dimension of the grip member extends to an outside of a process cartridge mounting region of an image forming apparatus.

52. An image forming apparatus comprising an image forming apparatus main body to which a developing device having a side cover as set forth in claim 41 and an electrophotographic photosensitive member are mounted.

53. An image forming apparatus comprising:
a process cartridge including a developer device having a side cover as set forth in claim 41, and an electrophotographic photosensitive member; and
an image forming apparatus main body to which the process cartridge is mounted.
